(19) United States
(12) Patent Application Publication
(10) Pub. No.: US 2013/0295454 A1
(43) Pub. Date: Nov. 7, 2013

(54) LOW CRYSTALLINITY SILICON COMPOSITE ANODE MATERIAL FOR LITHIUM ION BATTERY

(71) Applicant: ActaCell Energy Systems, Inc., (US)

(72) Inventors: Haitao Huang, Austin, TX (US); Cedric Weiss, Austin, TX (US); Yazid Saidi, Cedar Park, TX (US)

(21) Appl. No.: 13/861,871

(22) Filed: Apr. 12, 2013

Related U.S. Application Data
(60) Provisional application No. 61/623,420, filed on Apr. 12, 2012.

(51) Int. Cl. H01M 4/134

(52) U.S. Cl. CPC H01M 4/134
USPC 429/211; 429/215; 252/182.1; 252/511; 252/512

(57) ABSTRACT

An electrode composition that includes the combination of a finely ground silicon mixture, a partially carbonized polymeric material, and a buffering agent is disclosed. The silicon mixture can be formed by mechanical milling of crystalline silicon to create amorphous silicon particles, while the polymeric material can be formed from polymers such as polystyrene, polyethylene, polypropylene, polyacrylonitrile, polyvinyl chloride, polyethylene oxide that are heated under inert gasses to slightly decompose the polymers.

### PRIORITY CLAIM

This application claims the benefit of U.S. Provisional Application No. 61/623,420 filed on Apr. 12, 2012.

### BACKGROUND OF THE INVENTION

1. Field of the Invention

The present invention relates in general to the development of novel composite materials, and more particularly, to the development and use of novel silicon nanocomposite anode materials useful in lithium ion cells and batteries.

2. Description of the Relevant Art

Lithium ion batteries have become the choice power sources for portable electronic devices such as cell phones, laptops, and tablet computers due to their higher energy density compared to other rechargeable systems. They are also being intensively pursued for plug-in hybrid electric vehicles (PHEV) and electric vehicles (EV). Lithium ion batteries generally use graphite as the anode due to its excellent cycling behavior. However, the currently used carbon-based anodes have the drawbacks of limited capacity (372 mAh/g) and safety concerns. Particularly, the formation of a solid-electrolyte interfacial (SEI) layer by reaction of the carbon anode surface with the electrolyte and the high potential for lithium plating on the carbon anode, arising from a charge/discharge potential close to that of Li/Li⁺, pose serious safety concerns. These difficulties have created enormous interest in the development of alternate anode materials.

Silicon has received attention as an anode material for high energy density batteries. Silicon, when alloyed with lithium, forms the end-member Li_{4.4}Si composition that can deliver a capacity as high as 4400 mAhg⁻¹, higher than any other anode material known today. However, like many other metal alloy materials, Si suffers from significant volume changes, as high as 400%, during the Li alloying and de-alloying reactions. Repeated expansion and contraction on cycling will cause pulverization and/or cracking of the anode material. This can destroy the electrode integrity via electrical isolation between particles and current collector so that metal alloy material performance is greatly compromised and exhibits very poor cycle life.

The need to use a nano size form of the material and/or a nano composite matrix has been accepted and applied to address these large volume changes. Preparation of nanoparticles of silicon quite often involves use of methods such as: SiH₄ chemical vapor deposition (CVD) or thermal vapor deposition (TVD); the reverse micelles method in which organic silicon compounds, e.g. RSiCl₃ (R═H, C₈H₁₇), organic surfactants and solvents are needed; or pyrolysis of silane polymer (e.g. polymethylphenylsiloxane, polyphenylsesquisiloxane). A chemical etch process of using HF as agent to treat silicon powder also has been proposed. All these synthetic methods significantly add to the cost of manufacturing and would, as a consequence, slow down adoption. Other concerns include the safety and environmental impact of these methods.

### SUMMARY OF THE INVENTION

In one embodiment, a method of making a nanocomposite, includes: forming a silicon mixture comprising silicon particles and buffering agent particles, wherein at least a portion of the silicon particles are micron-size crystalline silicon particles; subjecting the silicon mixture to a mechanical milling process to create a conductive milled mixture, wherein the mechanical milling process converts at least a portion of the crystalline silicon particles to amorphous silicon particles; combining the milled mixture with a polymeric material to form a polymeric milled mixture; and heating the polymeric milled mixture at a time and temperature sufficient to decompose at least a portion of the polymer, wherein at least a portion of the polymeric material is not carbonized during the heating of the polymeric milled mixture.

A silicon nanocomposite, in one embodiment, includes amorphous silicon nanoparticles; conductive carbon particles; particles of a buffering agent; and an at least partially decomposed polymeric material, wherein at least a portion of the decomposed polymeric material is a non-carbonized material.

### BRIEF DESCRIPTION OF THE DRAWINGS

Advantages of the present invention will become apparent to those skilled in the art with the benefit of the following detailed description of embodiments and upon reference to the accompanying drawings in which:

FIGS. 1A-C depict the effects of milling time on the intensity of the silicon [220] peak using X-ray diffraction analysis.

FIG. 2 depicts a graph of silicon crystallite size vs. milling time derived from the Si [220] peak using the Debye-Scherrer equation.

FIG. 3A depicts an X-ray diffractogram of the silicon [111] peak for a Si composite that was milled for 10 hours;

FIG. 3B depicts an X-ray diffractogram of the silicon [111] peak for a Si composite that was milled for 3 hours;

FIG. 4 depicts the capacity retention of an electrochemical cell containing an amorphous silicon composite milled for 10 hours (crosses) compared to a cell containing a crystalline silicon composite milled for 3 hours (diamonds) and untreated micron-sized silicon powder (triangles);

FIG. 5A depicts the effect of having a buffer agent on the Si-composite capacity retention during a cycle life test (with buffer=diamonds; without buffer=crosses);

FIG. 5B depicts the cycle life of a Si composite sample prepared from mixing pre-formed nano-Si material and carbon;

FIG. 6 depicts the effect of temperature on the conductivity of a polymer/Al₂O₃ matrix (diamonds=polystyrene block polymer; triangles=polyacrylonitrile);

FIG. 7 depicts the effect of temperature on the capacity retention for an electrochemical cell made using a heat treated polymeric milled composition as the anode and a lithium metal counter electrode;

FIG. 8 shows the effect of different heat treated polymers on capacity retention (polystyrene block polymer=solid line; polyacrylonitrile=crosses);

FIG. 9 shows a comparison of the capacity retention of electrochemical cells comprising a polymer heat treated Si composite (triangles) and untreated Si composite (crosses);

FIG. 10A depicts an XRD plot of a sample of Si, SiC, and C milled for 12 hours;

FIG. 10B depicts an XRD plot of a sample of Si and SiC milled for 8 hours, followed by 4 hours of low energy milling with C;

FIG. 11A depicts the change in voltage profile and the realized specific anode capacity for the first 3 cycles during charge and discharge of a battery comprising a sample of Si, SiC, and C composite milled for 12 hours;

FIG. 11B depicts the change in voltage profile and the realized specific capacity for the first 3 cycles during charge and discharge of a battery comprising a sample of Si and SiC composite milled for 8 hours, followed by 4 hours of low energy milling with C;

FIG. 12 depicts comparative capacity retention as a function of cycle life for two Si composites with carbon either added after the high energy milling step (triangles) or during the high energy milling step (squares);

FIG. 13 depicts capacity retention as a function of rate applied for a Si composite sample comprising 45% Si, 35% SiC and 20% carbon;

FIG. 14 depicts the capacity retention of the lithium cell made according to Example 1; and

FIG. 15 depicts the capacity retention of the lithium cell made according to Example 2;

FIG. 16 depicts the capacity retention of the lithium cell made according to Example 4.

While the invention may be susceptible to various modifications and alternative forms, specific embodiments thereof are shown by way of example in the drawings and will herein be described in detail. The drawings may not be to scale. It should be understood, however, that the drawings and detailed description thereto are not intended to limit the invention to the particular form disclosed, but to the contrary, the intention is to cover all modifications, equivalents, and alternatives falling within the spirit and scope of the present invention as defined by the appended claims.

### DETAILED DESCRIPTION OF THE PREFERRED EMBODIMENTS

It is to be understood the present invention is not limited to particular devices or methods, which may, of course, vary. It is also to be understood that the terminology used herein is for the purpose of describing particular embodiments only, and is not intended to be limiting. As used in this specification and the appended claims, the singular forms “a”, “an”, and “the” include singular and plural referents unless the content clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

In an embodiment, silicon nanocomposites which exhibit excellent capacity retention with high capacity and rate capability are used to form battery electrodes. As used herein the term “nanocomposite” refers to a composition that includes nanoparticles of one or more compounds. “Nanoparticles” as used herein, refers to particles having an average diameter of less than 1 micron.

In one embodiment, a nanocomposite includes amorphous silicon nanoparticles, conductive carbon particles, nanoparticles of a buffering agent, and an at least partially decomposed polymeric material, wherein at least a portion of the decomposed polymeric material is a non-carbonized material. The nanocomposite may be used to overcome some of the problems associated with conventional electrode materials.

The nanocomposite may be formed by a series of process steps. In an embodiment, a silicon mixture is formed. In one embodiment, the silicon mixture includes micron size silicon particles and buffering agent particles. At least a portion of the silicon particles are crystalline silicon particles. Silicon particles used to form the nanocomposite may have an average particle size of less than 50 microns, less than 40 microns, less than 30 microns, less than 20 microns, less than 10 microns, or less than 5 microns. In some embodiments, the silicon particles may be 325 mesh particles or 400 mesh particles.

The silicon may be present in the silicon mixture in an amount ranging from about 10% to about 70% by weight of the composite. In other embodiments, the concentration of silicon in the silicon mixture is between about 20% and about 70% by weight. In other embodiments, the concentration of silicon in the composition is between about 40% and about 50% by weight. Ideally the concentration of silicon is selected to be the maximum concentration to increase the capacity of the electrode. The concentration, however, is limited by the volume expansion of the silicon upon reaction with lithium. Thus the concentration of silicon present in an electrode is selected to maximize the current capacity as well as maximize the cycle life.

Most materials when present in a nano-form have a higher tendency to re-agglomerate and in the case of the silicon nanoparticles, in order to inhibit such agglomeration, a buffering agent is present as part of the silicon mixture. A buffering agent is a compound which inhibits agglomeration of the silicon nanoparticles produced by the mechanical milling process, and may also assist in the reduction of particle size and/or increase the degree of amorphous nature of the resulting silicon particles. The buffering agent, in some embodiments, is also a conductive material that improves the conductivity of the resulting composite. The use of a buffering agent is also very important in improving the cycle life and the capacity retention of the resulting electrode.

Examples of buffering agents include, but are not limited to: oxides, carbides, silicides, nitrides, and borides. Examples of oxides that may be used as dispersive buffering agents include, but are not limited to: SiO₂; Li₂SiO₃; MgO; CaCO₃; LiAlO₂; Al₂O₃ and MgAl₂O₄. Examples of carbides that may be used as dispersive buffering agents include, but are not limited to: SiC; Al₃C₄; B₄C, and TiC. Examples of silicides that may be used as dispersive buffering agents include, but are not limited to: MgSi; CaSi₂; CoSi₂; NiSi₂; and FeSi₂. Examples of nitrides and borides that may be used as dispersive buffering agents include, but are not limited to: TiN; SiB₃; and TiB₂. Buffering agents may have an average particle size of less than 50 microns, less than 40 microns, less than 30 microns, less than 20 microns, less than 10 microns, or less than 5 microns. Typical properties of some buffering agents are set forth in Table 1; thus the buffering agent may be selected to give properties of electronic conductivity and/or toughness to to the resulting composite as desired.

TABLE 1

| | Electronic | | |
|---|---|---|---|
| | conductivity | Fracture toughness | hardness |
| Material | (S/cm) | (MPa/m²) | (Mohs) |
| BN | 10⁻¹⁴ | 5 | 2.0 or 9.5-10 |
| | | | (phase dependent) |
| B₄C | 10⁻¹ to 10² | 3 | 9.5 |
| TiN | 10⁻⁶ | 5 | 9.0 |
| TiB₂ | 10⁻⁵ | 6 | 9.5-10 |
| TiC | 1 | 4 | 9.0-9.5 |
| SiO₂ | 10⁻¹⁸ | 1 | 7.0 |
| Al₂O₃ | 10⁻¹⁶ | 4 | 9.0 |
| SiC | 10⁻⁶ | 4 | 9.0-9.5 |

The silicon mixture is subjected to a mechanical milling process. During the mechanical milling process, at least a portion of the silicon micron size particles are reduced to nanoparticles to form a milled mixture. Mechanical milling of the silicon mixture is, in some embodiments, performed until the average particle size of the mixture is less than 200 nm, less than 100 nm, less than 50 nm, or less than 5 nm. Furthermore, the silicon particles change from a highly crystalline material to a lower crystalline/amorphous material during the milling process, as determined by the height and width of characteristic Si diffraction peaks by XRD analysis. The other components of the silicon mixture (e.g., the conductive carbon particles and the buffering agents) are also reduced to nanoparticles during the milling process. This produces a silicon-carbon-buffering agent nanocomposite which includes amorphous silicon nanoparticles.

Mechanical milling may be accomplished using a number of known mechanical milling devices. Examples of techniques that may be used for performing mechanical milling include, but are not limited to, ball milling, impact milling, attrition milling, knife milling, and direct-pressure milling. A ball mill or attritor may be used to conduct the milling process. In a ball milling or attritor process, small balls of a hardened material (e.g., stainless steel or yttrium stabilized zirconia (YSZ)) move within the container containing the silicon mixture. The speed at which the balls are moved within the container, the size of the balls, and the time of milling, can all influence the resulting particle size. Generally, milling is conducted at a high rotational speed to convert the crystalline silicon particles to amorphous particles. For example, a ball milling process may be conducted at speeds greater than 1000 rpm, greater than 900 rpm, or greater than 800 rpm. Lower speeds may be used for mixing (e.g., less than 500 rpm). Lower speed milling may be used to mix, blend particles, without impacting their particle size and/or morphology. This may also assist in improving connectivity between components resulting in changes of one or more physical properties in the final composite such as its electronic conductivity.

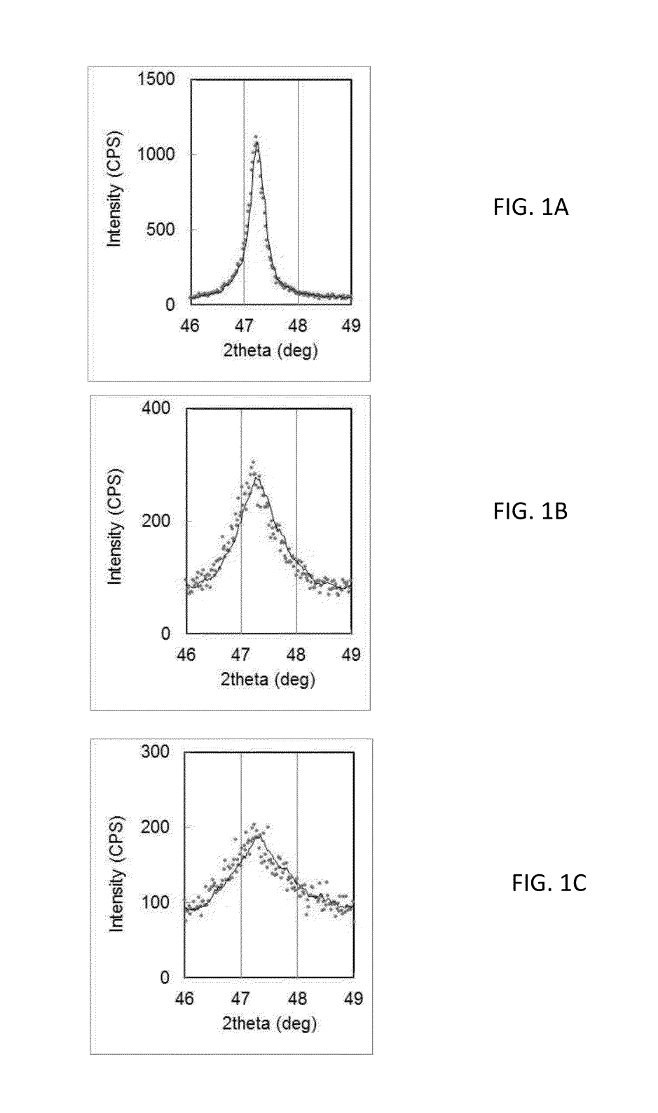

The effect of milling conditions on the crystallinity of the silicon particles in the resulting milled mixture was investigated. Si (35% by weight), SiC (45%) and SuperP (carbon black, 20%) were mixed and milled for 1 h, 3 h, and 5 h (using ⅛″ YSZ media), respectively. FIG. 1A depicts an X-ray diffraction scan after 1 h of milling time. FIG. 1B depicts an X-ray diffraction scan after 3 hours of milling time. FIG. 1C depicts an X-ray diffraction scan after 5 hours of milling time. X-ray diffraction shows significant reduction of crystallinity depending on mill time. Such reduction in crystallinity is reflected in the reduction in a concurrent reduction in intensity and broadening of the primary Si [220] peak located at 47.30 on the 20 scale. By 5 hours, the milled mixture contains predominantly amorphous silicon particles. The crystallite size can be determined from the XRD scans depicted in FIG. 1 using the Debye-Scherrer equation.

$$Debye \text{-} Scherrer equation \text{:} B ( 2 θ ) = \frac{K λ}{L cos θ}$$

Peak width (B) is inversely proportional to crystallite size (L).

Θ: diffraction angle

λ: X-ray wavelength (for Cu anode=1.5418 [symbol] )

K=0.9

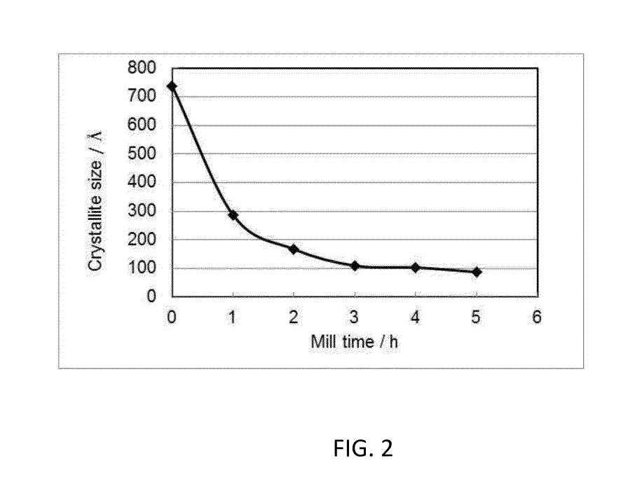

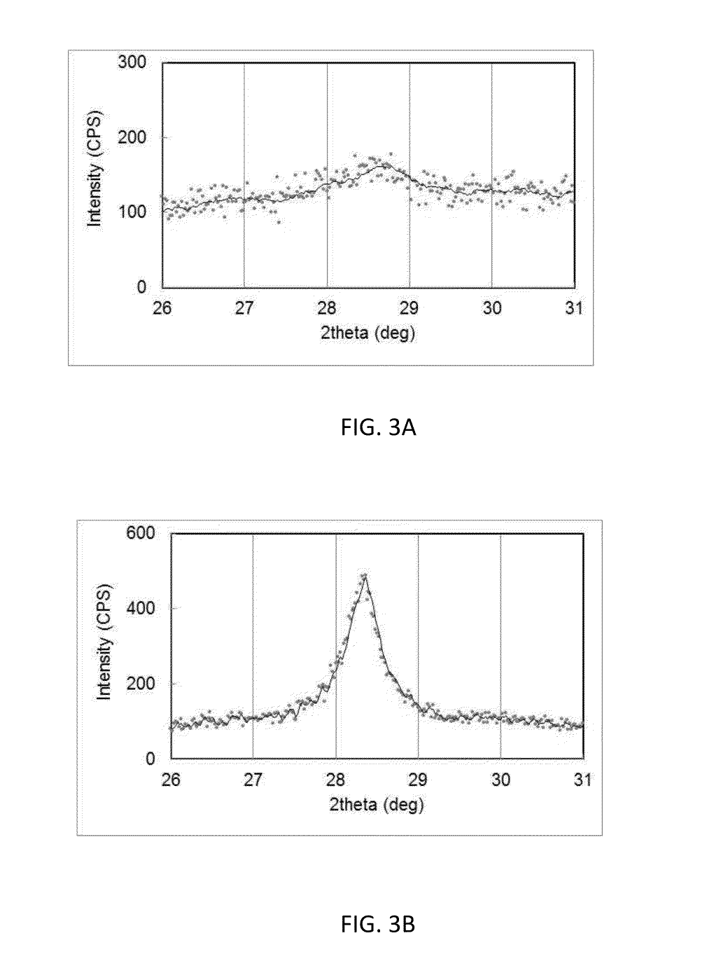

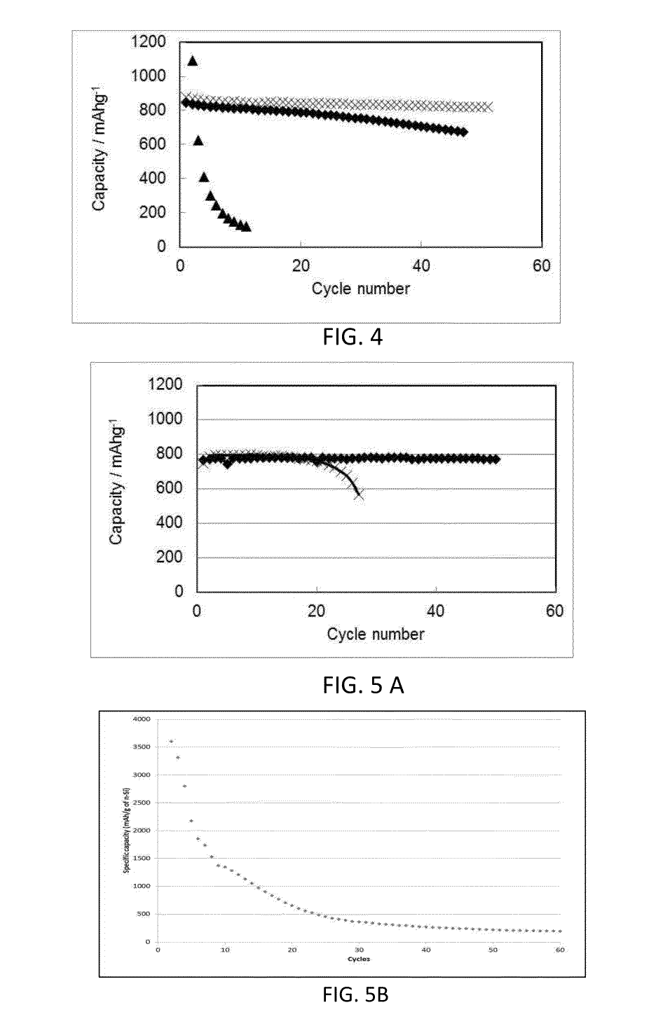

The relationship between milling time and the crystallite size is shown in FIG. 2 and derived from analysis of the Si [220] peak. As can be seen, after 3 hours of milling, the crystallite size is less than 100 Å. It should be understood that milling time is dependent on a number of conditions including initial particle size, speed of rotation, media size, etc. Any of these conditions can be modified for convenience, as long as a substantial amount of the crystalline silicon particles are reduced to amorphous nanoparticles
The use of amorphous silicon in an anode has been found to be beneficial for the cycle life of an anode formed using the amorphous silicon based composite. Three tests were run to illustrate this effect. A composition that includes amorphous silicon particles (45%), SiC nanoparticles (35%) and carbon black (Super P, 20%), by weight, was produced by milling silicon particles, SiC particles and carbon black for 10 hours in a ball mill. The XRD of the resulting sample is shown in FIG. 3A. The lack of a significant peak (low angle Si peak [111] located at 28.44 on the 2θ scale indicates that most, if not all, of the crystalline silicon has been converted to amorphous silicon. A second composition was prepared from a mixture that contained crystalline silicon particles (25%), SiC particles (55%), and carbon black (20%) by weight and was produced by milling silicon particles, SiC particles and carbon black for 3 hours in a ball mill at high energy. The ratio of Si to SiC was herein adjusted to ensure that the starting capacities of the two mixtures are similar to allow for a realistic and meaningful comparison of their capacity retention. This was done in consideration that materials with different starting capacities would have different fade characteristics. The XRD of the resulting sample is shown in FIG. 3B. The Si [111] peak located between 28 and 29 (2θ) indicates that the second sample still contains a significant amount of crystalline silicon. By matching the initial capacity of the two composite variants, the capacity retention (expressed as fade of the starting capacity during cycle life) of the two samples was investigated. To further illustrate the importance of the amorphous character, a third Si composite sample where the Si composite was used as is and not milled (thereby highly crystalline) is also included in FIG. 4. As can be seen in FIG. 4, there is no significant capacity fade for the first sample (amorphous silicon, crosses). The second sample (crystalline silicon, diamonds) shows significant capacity fade after 20 cycles, whereas the highly crystalline Si (indicated with triangles in FIG. 4) when used as is and without prior milling exhibits very severe fade characteristics. These results are in line with the degree of crystallinity of each sample and emphasize the essential aspect of size reduction together with the amorphous character in order to sustain cycle life.

The effect of the buffer agent was also studied. Two samples were therefore prepared. A first sample was prepared and comprised crystalline Si (325 mesh), SiC, and carbon black (Super P) such that the Si content in the sample was 42% by weight. A second sample was prepared from Si (325 mesh) where no buffer agent (SiC) was included. The samples were used to prepare an electrochemical cell and the capacity retention was tested over 50 cycles against a lithium metal electrode. The results are presented in FIG. 5A. The data represented by diamonds shows the sample that has a buffer agent present during the milling process, and the data represented by crosses shows the sample without a buffer agent. It is noted that the use of a buffer agent provides a significant improvement to the capacity retention by extending cycle life. The benefit from the presence of a buffer agent emphasizes the need for containing the significant volume changes that the Si active component experienced during the discharge and charge reactions by spatial dilution of the active Si within a hard medium with high fracture-toughness. Furthermore, besides the understood need for size reduction and the amorphous character of the Si composite, the buffer matrix and its method of incorporation into the final composite using the high energy milling process is also critical. A Si composite sample prepared by mixing a pre-formed nano-Si material (Aldrich, <50 nm) with carbon in 1:1 weight ratio and tested in an electrochemical yields a very poor cycle life as shown in FIG. 5B. Therefore, starting from a micron sized Si material and engineering the composite via a high energy milling process together with a buffer matrix is critical as it results in much improved electrochemical performance.

To further enhance the properties of the nanocomposite, a polymeric material may be added to the milled mixture to form a polymeric milled mixture. The polymeric milled mixture may be heated at a temperature and for a time sufficient to decompose at least a portion of the polymer, while at least a portion of the polymer is not carbonized during heating of the polymeric milled mixture. The term “carbonized”, as used herein, refers to a decomposition product in which substantially all of the polymeric material is converted into elemental carbon. Heating of the polymeric material is controlled to allow a portion of the polymeric material to decompose while the carbonization of the polymeric material is inhibited or reduced by the selection of the appropriate heating conditions. The heating process is conducted in an inert atmosphere to prevent oxidation of the materials in the polymeric milled mixture. Examples of gases used to form an inert atmosphere include, but are not limited to, argon and nitrogen.

Many different types of polymeric materials may be used, including, but not limited to, polystyrene, polyethylene, polypropylene, polyacrylonitrile, polyvinyl chloride, polyethylene oxide, or mixtures thereof. In some embodiments, it has been found that polymers that include polystyrene, including homopolymers of polystyrene and mixed polymers that contain polystyrene, are particularly useful for improving the cycle life properties of the resulting battery made using the produced nanocomposite. Examples of polystyrene based polymers include, but are not limited to, polystyrene, styrene-butadiene copolymers (e.g., styrene-butadiene block copolymers), styrene-ethylene/butylene-styrene copolymers (e.g., styrene-ethylene/butylene-styrene block copolymers), and styrene-ethylene/butylene-styrene-graft maleic anhydride copolymers.

Decomposition of a polymeric material, while minimizing the formation of carbonized material, may, in some embodiments, be accomplished by heating the polymer to a temperature of between about 400° C. and 750° C. for a time of about 1 to 2 hours. Since each polymer has different decomposition properties, the decomposition process may be customized for each polymer. Generally, polymers undergo weight loss as the polymer is decomposed. The maximum weight loss occurs when all of the polymeric material is carbonized. Decomposition conditions can be determined by monitoring the weight loss of the polymer species as the material is heated. To prepare a sample for use in a battery, the heating is stopped before the material is completely carbonized. In some embodiments at least 10%, at least 25% or at least 50% of the polymeric material is not carbonized during the heating process.

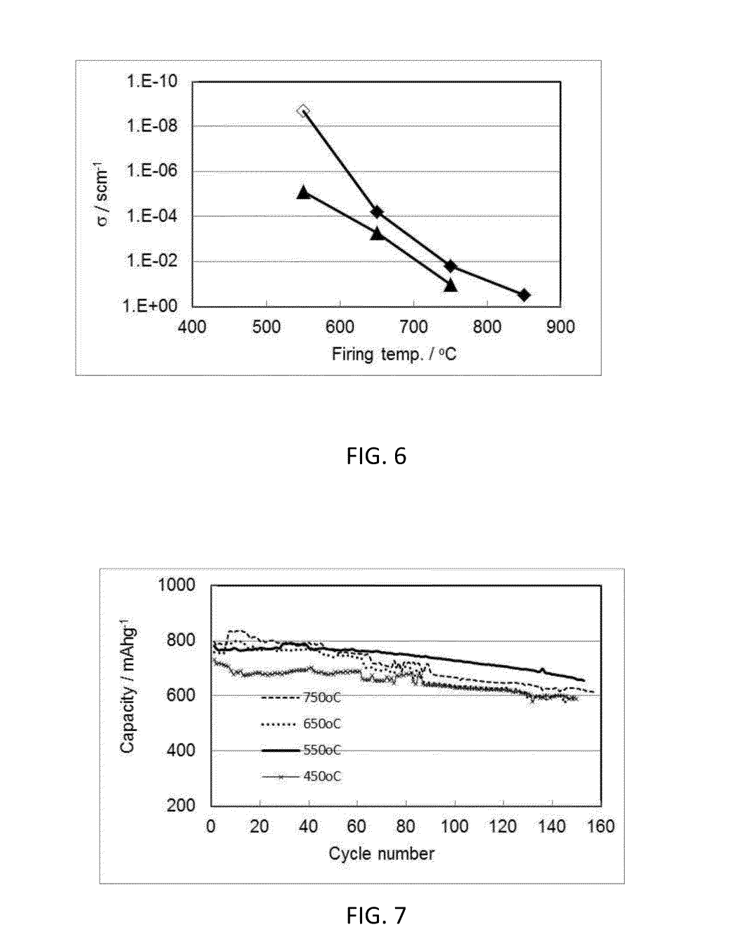

The effect of thermal treatment of the conductivity of the samples was determined by forming a mixture of the polymer (Polystyrene-block-poly(ethylene-ran-butylene)-block-polystyrene block copolymer or polyacrylonitrile polymer) with 33% Al₂O₃. Each of the polystyrene block copolymer was heated at 550° C., 650° C., 750° C. and 850° C. The polyacrylonitrile samples were heated at 550° C., 650° C., and 750° C. The powders were ground after thermal treatment and the electrical conductivity of the resulting mixture was measured at a fixed 0.22 US tonne/cm². A graph of the results is presented in FIG. 6 (diamonds for the polystyrene sample and triangles for the polyacrylonitrile sample). It is observed that the highest electrical conductivity was achieved for the samples that were heated above 700° C., in turn corresponding to the greatest degree of carbonization.

Cycle life of batteries formed with polymers that have been decomposed, but not significantly carbonized, was also investigated. A milled mixture was prepared that includes, by weight, amorphous silicon (40%), silicon carbide (40%) and carbon black (Super P, 20%). The milled mixture was blended with 25% of Polystyrene-block-poly(ethylene-ran-butylene)-block-polystyrene powder (average Mw ˜118,000 by GPC). The resulting first polymeric milled mixture was heated, under argon, at temperatures of 450° C., 550° C., 650° C., and 750° C. A second polymeric milled sample was prepared using the same milled mixture blended with polyacrylonitrile (Mw: 150,000). The polyacrylonitrile sample was heated at 550° C., 650° C., and 750° C. The heated polymeric milled material was incorporated into a Li battery for further electrochemical tests

FIG. 7 shows a graph of capacity retention vs. number of cycles for the polystyrene block copolymer polymeric milled sample heated at different temperatures (450° C., 550° C., 650° C., and 750° C.). The dashed line represents the sample heated to 750° C., the dotted line represents the sample heated to 650° C., the solid line represents the sample heated to 550° C., and the crossed line represents the sample heated to 450° C. The highest electronic conductivity (FIG. 6) was achieved for samples containing the polystyrene block copolymer that was heated at temperatures at least or above 700° C. However, cycling tests (FIG. 7) show that 550° C. treatment, at which polystyrene block copolymer gives a conductivity lower than 10⁻⁹ Scm⁻¹, exhibits the best capacity retention. This indicates that heat treatment below the carbonization point provides a small amount of decomposed, but not carbonized, residual material which combines with the rigid buffer agent (e.g., SiC) to enhance resistance against volume change during cycling.

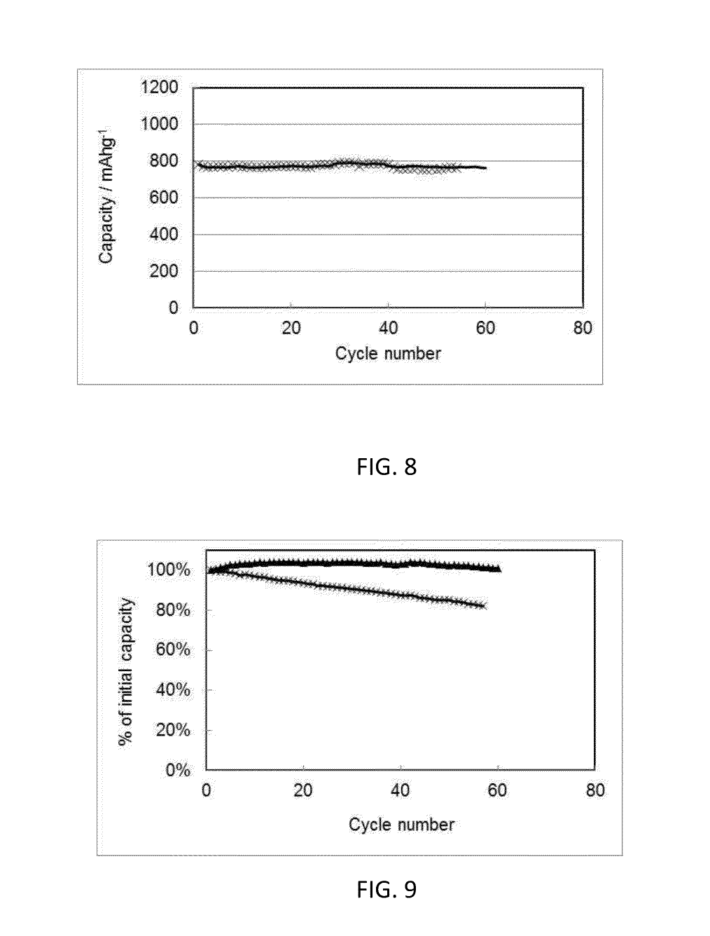

FIG. 8 shows a comparative graph of the capacity retention for polystyrene block copolymer and polyacrylonitrile, both heated at 550° C. The solid line represents the polystyrene block copolymer sample, the crossed line represents the polyacrylonitrile sample. The measured conductivity of the polyacrylonitrile samples, heated at 550° C. is 10⁻⁶ Scm⁻¹ (FIG. 6). The capacity retention, however, was found to be similar to the polystyrene block copolymer (FIG. 8).

The effect of heat treatment was also compared to an untreated sample. Two samples were prepared: a first milled mixture was prepared that includes amorphous silicon (45%), silicon carbide (35%) and carbon black (Super P, 20%) by weight. The first milled mixture was blended with 25% of Polystyrene-block-poly(ethylene-ran-butylene)-block-polystyrene powder (average Mw ˜118,000 by GPC). The resulting first polymeric milled mixture was heated, under argon, at a temperature of 550° C. A second milled mixture that includes amorphous silicon (45%), silicon carbide (35%) and carbon black (Super P, 20%) was blended, by weight, with 25% of Polystyrene-block-poly(ethylene-ran-butylene)-block-polystyrene powder (average Mw ˜118,000 by GPC). The resulting polymeric milled mixture was not treated with heat. FIG. 9 depicts a graph of the capacity retention of each sample. The triangles represent the heat treated sample and the crosses represent the untreated sample. FIG. 9 shows that a significant improvement in capacity fade is achieved by the heat treatment of the polymeric milled mixture. It is believed that the presence of the heat treated polymeric material helps stabilize a solid-electrolyte interface (SEI) formed upon cycling, as thus enhances the cycle life of an electrode. When the heat treated polymeric material is not present, the electrode has a shorter cycle life and a reduced capacity when compared to the same electrode incorporating the treated polymeric material.

To improve the conductivity of the nanocomposite, a conductive carbon material may also be present. Conductive carbon materials that may be used include, but are not limited to: natural graphite species, such as scaly graphite, flaky graphite, and earthy graphite; artificial graphite species obtained by calcining petroleum coke, coal coke, cellulosic materials, saccharides, mesophase pitch, etc. at high temperature; artificial graphite species obtained by vapor-phase growth; carbon black species such as acetylene black, furnace black, Ketjen black, channel black, lamp black, and thermal black; and other carbon materials such as asphalt pitch, coal tar, activated carbon, mesophase pitch, and polyacene. Carbon black, acetylene black and/or graphite are used as the conductive carbon particles in some embodiments. Conductive carbon particles may have an average particle size of less than 50 microns, less than 40 microns, less than 30 microns, less than 20 microns, less than 10 microns, or less than 5 microns.

The carbon material may be incorporated into the silicon mixture before milling or after milling. In one embodiment, a silicon mixture is formed that includes silicon particles, buffering agent particles, and conductive carbon particles. The silicon mixture, containing the conductive carbon particles is milled to convert at least a portion of the silicon particles to amorphous silicon particles. The resulting milled mixture is combined with a polymeric material and heated. In an alternate embodiment, a silicon mixture is formed that includes silicon particles and a buffering agent particles, but no conductive carbon particles. The silicon mixture is milled to convert at least a portion of the silicon particles to amorphous silicon particles. The resulting milled mixture is combined with a conductive carbon particles and the mixture is milled at low energy (e.g., at less than 500 rpm) to mix the conductive carbon particles with the milled silicon mixture. Polymeric material is then added to the milled mixture that includes conductive carbon particles, and heated.

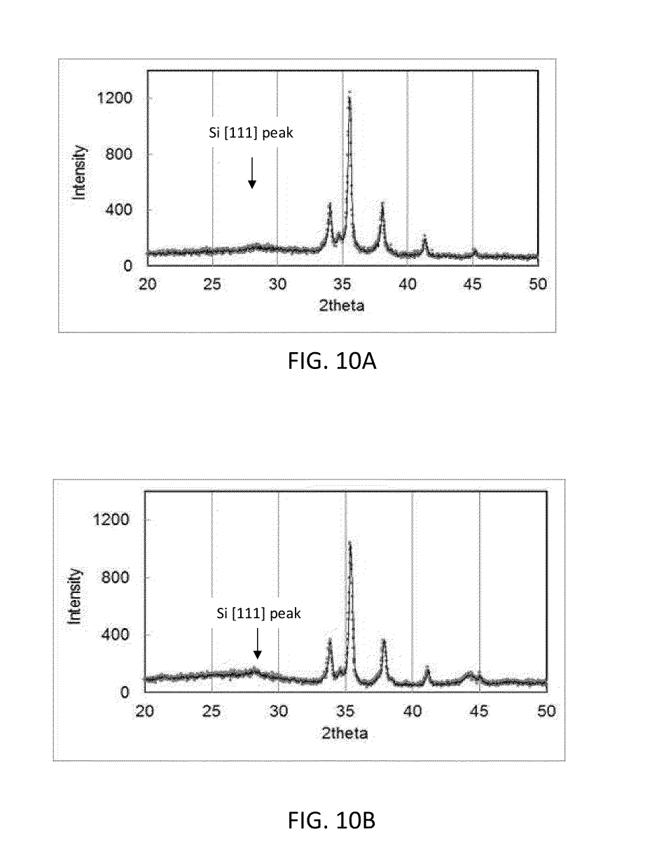

Adding the conductive carbon particles after the silicon has been converted to amorphous form was found to enhance the cycle life. In a test, a first sample was prepared (Sample A) by milling a silicon mixture that includes silicon particles (40%), buffer agent (SiC, 40%) and conductive carbon (Super P, 20%) under high energy conditions for 12 hours. Sample A was used to form a lithium cell. Sample B was prepared by milling a silicon mixture that includes silicon particles (40%) and a buffer agent (SiC, 40%) under high energy conditions for 8 hours. Carbon black (Super P) is added to the milled mixture to form a carbon-milled mixture. The carbon-milled mixture is mixed in a planetary mill at 400 rpm for 4 hours. Sample B also has a composition of Si (40%), SiC (40%), and carbon black (Super P, 20%). X-ray diffraction patterns (XRD) show that both Samples A (FIG. 10A) and Sample B (FIG. 10B) include amorphous silicon particles.

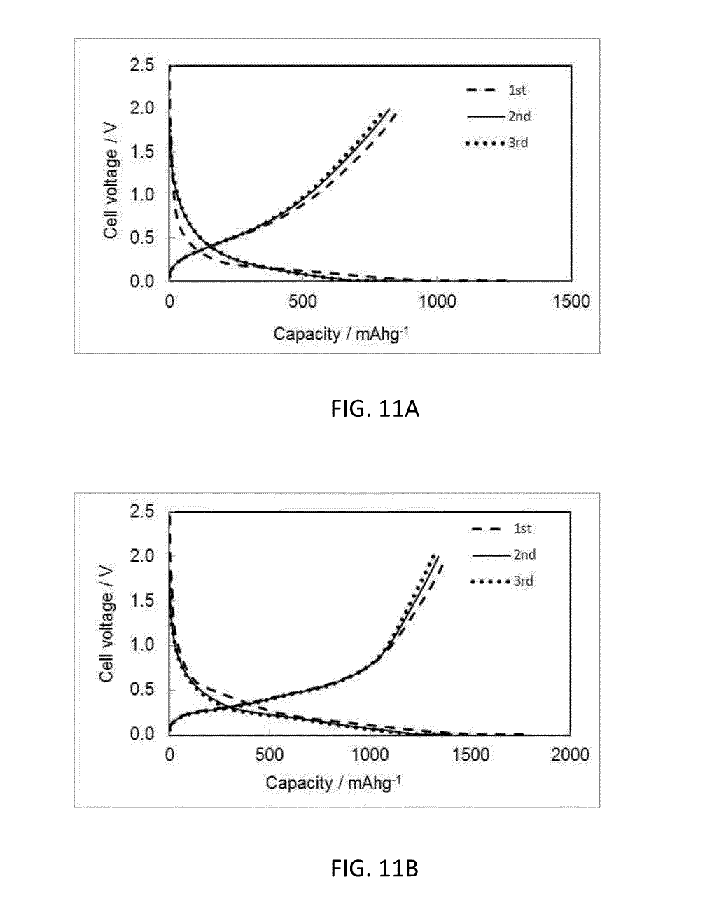

Sample A was tested in a Li cell at C/15. FIG. 11A shows voltage profiles during charge and discharge of the Sample A Li cell. The reversible capacity is 850 mAh/g (first charge is 1280 mAh/g). Sample B was tested in a Li cell at C/15. FIG. 11B shows voltage profiles during charge and discharge of the Sample B Li cell. The reversible capacity is 1300 mAh/g (first charge is 1750 mAh/g). The Sample B cell shows that capacity of the material can be significantly improved by adding the conductive carbon material after the high energy milling process is complete.

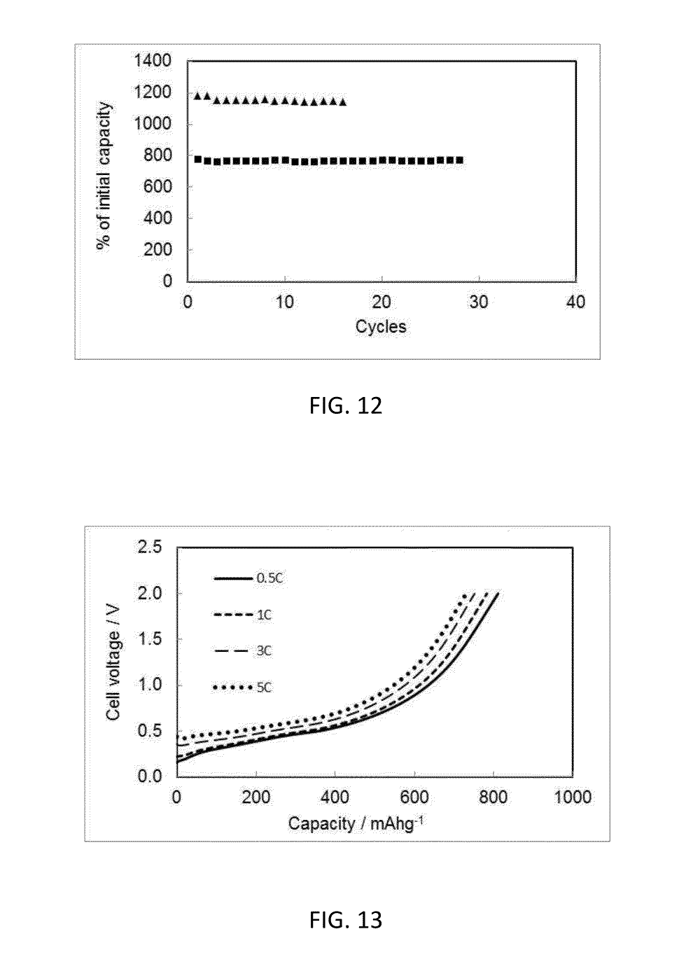

Without being bound to any particular theory, the difference in realized capacity between the two samples may be tied to a solid state reaction between the carbon and the Si (during the ball milling process) that takes place at the interface of these couples to form a beta-phase of SiC via diffusion of C atoms into Si then displacement of Si to form SiC. Using the concentration of Si used in sample B, 40% Si content would deliver 40%×4400 mAh/g=1760 mAh/g (given that the end member of lithium alloying with silicon is Li_{4.4}Si, with a theoretical capacity of 4400 mAh/g). This is very close to the 1750 mAh/g charge capacity observed for the sample where the carbon was added and milled at much lower energy (400 rpm) after the high energy (1700 rpm) milling step of Si/SiC without carbon was completed. In sample A where the 40% Si was milled with SiC, the realized capacity during the charge step is only 1280 mAh/g. The difference, 1760-1280=480 mAh/g is equivalent to a loss of active Si˜10%. The impact of carbon addition on the realized capacity and cycle life is further captured in FIG. 12 which depicts the discharge capacity in mAh/g as a function of cycle life.

In some embodiments, conductive metal nanoparticles may also be present in the silicon nanocomposite. Conductive metal nanoparticles may be used to increase the capacity and rate capability of the resulting battery. Examples of conductive metal nanoparticles that may be present in the silicon nanocomposite include, but are not limited to, copper nanoparticles, aluminum nanoparticles, nickel nanoparticles, or mixtures thereof. In an embodiment, a conductive matrix can be produced in situ during the milling process used to produce the silicon nanoparticles.

The composite electrodes formed from the described silicon nanocomposites exhibit excellent electrochemical cycling performance and rate capability compared to other silicon containing electrodes used in lithium ion batteries. Such improvement can be noted in the rate capability enhanced characteristics of the resulting Si-composite prepared in this manner. FIG. 13 depicts the capacity retention as a function of the current that is applied to the cell (herein expressed as C-rate, where 1C rate is defined as the rate required to fully discharge the cell in one hour, conversely, a 5C rate is a full discharge in 60/5=12 minutes; therefore, the higher the rate the higher the power capability of the battery). It is shown that at 5C rate, 88% of the capacity recorded at 0.5C is still retained, indicating these composite electrodes have excellent rate capability.

The silicon nanocomposites described herein may be used for the manufacture of an anode of a lithium ion battery. A typical procedure for the preparation of a Li-ion battery anode includes mixing the silicon nanocomposite with a conductive carbon material and a polymeric binder dissolved in a solvent. The produced slurry is then cast on metal foil current collectors (e.g., copper foil) and dried. The silicon based anode may be used to form a lithium ion battery. In an embodiment, the silicon based anode is placed in a container having a cathode that includes a cathode active material and a separator. Examples of cathode active materials include, but are not limited to lithium cobalt oxide (LiCoO₂), spinel lithium manganese oxide (LiMn₂O₄), and olivine lithium iron phosphate (LiFePO₄). Other cathode active materials include cation-substituted spinel oxide and oxyfluoride cathodes as described in U.S. Pat. No. 7,718,319 and layered oxide cathodes as described in U.S. Pat. No. 7,678,503, both of which are incorporated herein by reference. An electrolyte is also present in the container disposed in the space between the anode and the cathode. LiPF₆ in ethylene carbonate (EC)/diethyl carbonate (DEC) (1:1 v/v) may be used as the electrolyte.

Examples of binders include but are not limited to: polyvinylidene fluoride (PVdF); polyacrylic acid (PAA); polyamide-imides (PAI); carboxymethyl cellulose (CMC); ethylene propylene diene monomer (EPDM); polytetrafluoroethylene (PTFE), PEO (Polyethylene oxide) polyacrylonitrile (PAN) etc.

### FURTHER EXAMPLES

The following examples are included to demonstrate preferred embodiments of the invention. It should be appreciated by those of skill in the art that the techniques disclosed in the examples which follow represent techniques discovered by the inventor to function well in the practice of the invention, and thus can be considered to constitute preferred modes for its practice. However, those of skill in the art should, in light of the present disclosure, appreciate that many changes can be made in the specific embodiments which are disclosed and still obtain a like or similar result without departing from the spirit and scope of the invention.

### Preparation of Silicon Nanocomposites

High energy ball milling was run using SPEX 8000. The media size was ¼″, ⅛″ or 1/16″ and the weight ratio of media to mixture powder is 10:1. Every one hour milling was followed at least by half an hour of cooling. The total mill time varied from 5 h to 12 h.

The silicon nanocomposite anode material was prepared by a mechanical milling process. Various amounts of silicon powders and buffering agents were mixed together prior to the milling process. Conductive carbon particles and/or conductive metal powders were also present in the mixture in various amounts. The mixture was then placed in a hardened steel vial with hardened steel grinding media using a high energy shaker miller (8000M SPEX mill). The weight ratio of media to the mixture powder was fixed at 10:1, and the media sizes used were ¼″, ⅛″, or 1/16″. Milling time varied from 5 h to 12 h. Each hour of milling was followed by at least 30 minutes of cooling.

After the milling process was complete, the polymeric material was blended with the milled mixture. The milled mixture was subjected to heating. The heat conditions are selected such that the polymeric milled mixture is heated to a temperature sufficient to decompose the polymeric material in such a way that at least a portion of the polymeric material is not carbonized.

Electrodes were made using traditional tape casting techniques: active material (silicon nanocomposite), 70%, Polyamide-imide, PAI), 15%, additional carbon (Super P): 15%. A mixture comprised of 70 wt. % active material (silicon nanocomposite) powder and 15 wt. % carbon black (Super P) were mixed in a mortar and pestle. The mixed powder was put into a 15 wt. % Polyamide-imide, PAI, dissolved in N-methylpyrrolidinone (NMP) to form a slurry, which was stirred for 12 h to have a homogeneous mixing. The slurry was spread onto a 10 μm thick Cu foil with a film applicator. The coated film was kept at 80° C. in an oven for 20 min to evaporate the NMP solvent, and cured at 120° C. for 2 h in a vacuum. The film was then pressed and cut into 1 inch diameter coupons. Pouch cells were then assembled in an Ar-filled glove box with the electrodes thus prepared, Celgard polypropylene separator, lithium foil as the counter electrode, and 1M LiPF₆ in ethylene carbonate (EC)/diethyl carbonate (DEC) (1:1 v/v) as the electrolyte. The discharge-charge experiments were performed galvanostatically at a constant current density of 100 mA/g of active material within the voltage range of 0-2 V vs. Li⁺/Li couple.

### Experiment 1

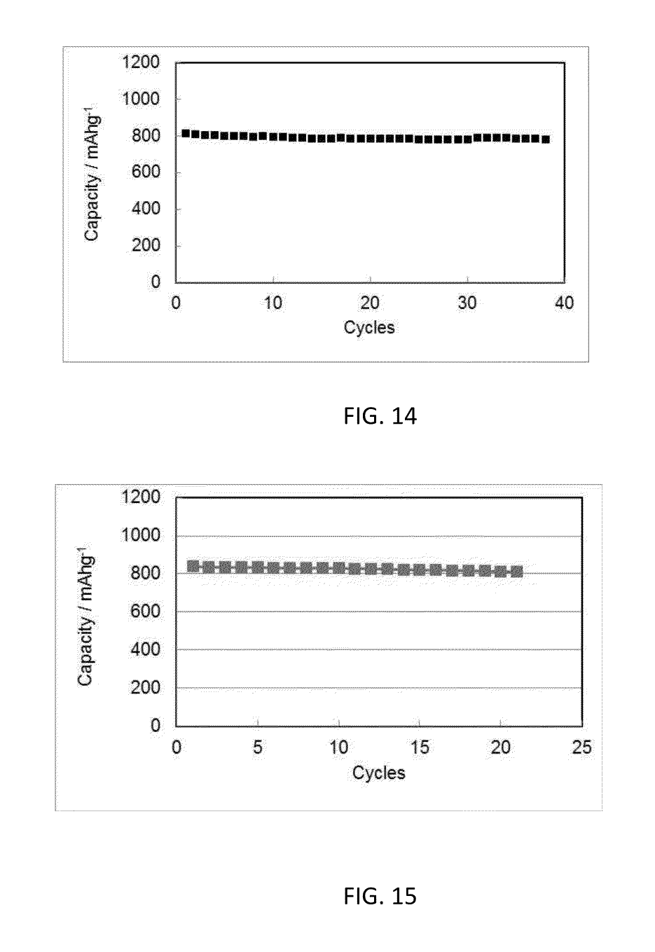

Si (42.5%), SiC (37.5%) and Super P (20%) by weight were mixed and milled for 10 hours (⅛″ media). After milling, 20% of a polystyrene block polymer was added into the mixture to form a polymeric milled mixture. The polymeric milled mixture was heated at 550° C. for 2 h. The resulting silicon nanocomposite was formed into an anode for a lithium ion battery. Li cell testing indicates that this composite has a starting capacity of 820 mAh/g and very good cycle life, see FIG. 14.

### Experiment 2

A composite was prepared from Si (35%), SiC (40%), graphite (20%), Cu (2.5%) and Al (2.5%). After 6 h milling, 17% of a polystyrene block polymer was added into the mixture and pyrolysis was performed at 550° C. for 2 h. The resulting silicon nanocomposite was formed into an anode for a lithium ion battery. Li cell testing indicates that this composite has a capacity of 800 mAh/g and very good cycle life, see FIG. 15.

### Experiment 3

Si (>98% purity, >5 μm average particle size) was blended with SiC (>97% purity, an average particle size ranging from 0.5-16 μm). The initial mixture has a 5:3 ratio of Si to SiC. Milling is performed for 6-12 hours in a large attritor or agitated mill at 320 RPM with an agitator diameter of 8″. The media to material ratio (ball to powder ratio) for this initial run is 50:1, by mass.

The resulting powder is then milled with a 1:4 ratio of carbon black (Super P), resulting in a composition of 50% Si, 30% SiC, and 20% amorphous C. Milling was performed with a ball to powder ratio of 40:1 over a period of 1-3 hours. Milling was performed at 106 RPM on the 1S machine with an 8″ diameter agitator. The resulting discharge capacity for the composite where the carbon was added and milled for one hour (after the higher energy step) delivered a discharge capacity of 1250 mAh/g.

### Experiment 4

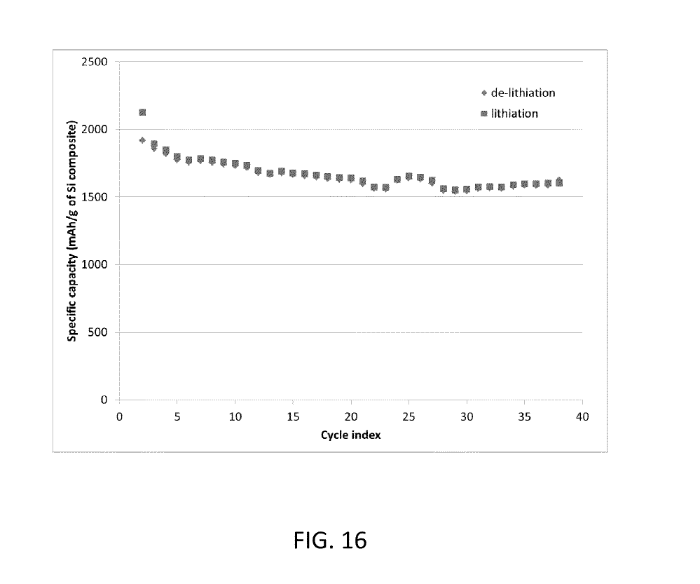

Si (62.5%) and SiC (37.5%) by weight were mixed and milled for 6 hours at 960 rpm with 5 mm diameter media in argon atmosphere. After milling, a slurry was formed with polyacrylonitrile (PAN) in dimethylformamide (DMF) (7:3 Si composite:PAN by weight). The slurry was then coated on a copper film and pyrolyzed at 550° C. for 1 h under argon flow. The resulting silicon nanocomposite was formed into an anode for a lithium battery. Li cell testing indicates that this composite has a starting capacity of about 1900 mAh/g at C/2 rate and very good cycle life, see FIG. 16.

In this patent, certain U.S. patents, U.S. patent applications, and other materials (e.g., articles) have been incorporated by reference. The text of such U.S. patents, U.S. patent applications, and other materials is, however, only incorporated by reference to the extent that no conflict exists between such text and the other statements and drawings set forth herein. In the event of such conflict, then any such conflicting text in such incorporated by reference U.S. patents, U.S. patent applications, and other materials is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as examples of embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A method of making a nanocomposite, comprising:
forming a silicon mixture comprising silicon particles and buffering agent particles, wherein at least a portion of the silicon particles are crystalline silicon particles;
subjecting the silicon mixture to a mechanical milling process to create a milled mixture, wherein the mechanical milling process converts at least a portion of the crystalline silicon particles to amorphous silicon particles;
combining the milled mixture with a polymeric material to form a polymeric milled mixture;
heating the polymeric milled mixture at a time and temperature sufficient to decompose at least a portion of the polymer, wherein at least a portion of the polymeric material is not carbonized during the heating of the polymeric milled mixture.

2. The method of claim 1, wherein the polymeric milled mixture is heated at a temperature of between about 450° C. to about 750° C. for a time of between about 1 hour to 2 hours.

3. The method of claim 1, wherein the mechanical milling process is a ball milling process.

4. The method of claim 1, wherein the silicon particles comprises about 10% to about 60% by weight of the composition.

5. The method of claim 1, wherein the silicon particles have an average particle size of between about 1 micron and about 10 microns.

6. The method of claim 1, wherein the silicon mixture further comprises conductive carbon particles.

7. The method of claim 6, wherein the conductive carbon particles comprise acetylene black, carbon black, graphite, or mixtures thereof.

8. The method of claim 1, further comprising:
adding conductive carbon particles to the milled mixture;
mixing the conductive carbon particles with the milled mixture;
adding a polymeric material to the milled mixture comprising conductive carbon particles to form the polymeric milled mixture

9. The method of claim 8, wherein the conductive carbon particles comprise acetylene black, carbon black, graphite, or mixtures thereof.

10. The method of claim 8, wherein mixing the conductive carbon particles with the milled mixture is performed using a low-energy milling process.

11. The method of claim 1, wherein subjecting the silicon mixture to a high energy mechanical milling process reduces the average particle size of the silicon mixture to less than 200 nm.

12. The method of claim 1, wherein the polymeric material comprises a polymer comprising polystyrene.

13. The method of claim 1, wherein the polymeric material comprises a polymer comprising polystyrene and polyethylene.

14. The method of claim 1, wherein the polymeric material comprises polyacrylonitrile, polyvinyl chloride or polyethylene oxide.

15. The method of claim 1, wherein the buffering agent is an oxide, a carbide, a silicide, a nitride, a boride, or mixtures thereof.

16. The method of claim 1, wherein the silicon mixture further comprises conductive metal particles.

17. The method of claim 16, wherein the conductive metal particles comprise copper nanoparticles, aluminum nanoparticles, nickel nanoparticles, or mixtures thereof.

18. A composition made by the method of claim 1.

19. An anode for a lithium ion battery comprising:
a composition made by the method of claim 1;
a binder;
a conducting agent; and
a current collector.

20. A lithium ion battery comprising:
a cathode comprising a cathode active material;
an anode, comprising:
a composition made by the method of claim 1;
a binder;
a conducting agent; and
a current collector;
a separator, positioned between the cathode and the anode; and
an electrolyte composition disposed between the cathode and the anode.

21. A silicon nanocomposite comprising:
amorphous silicon nanoparticles;
conductive carbon particles;
nanoparticles of a buffering agent; and
an at least partially decomposed polymeric material, wherein at least a portion of the decomposed polymeric material is a non-carbonized material.

22-41. (canceled)
